(19) United States
(12) Patent Application Publication
(10) Pub. No.: US 2004/0264841 A1
(43) Pub. Date: Dec. 30, 2004

(54) Adjusting carrier for setting optical elements

(76) Inventor: Gennady Ivanovich Utkin, Moscow (RU)

Correspondence Address: PAUL AND PAUL, 2900 TWO THOUSAND MARKET STREET, PHILADELPHIA, PA, 19103, US

(21) Appl. No.: 10/493,282

(22) PCT Filed: Oct. 25, 2001
(86) PCT No.: PCT/RU01/00444

(30) Foreign Application Priority Data
Apr. 13, 2001 (RU) 2001109756

(51) Int. Cl. G02B 6/26

(52) U.S. Cl. 385/16

(57) ABSTRACT

An adjusting carrier for setting optical elements may be used for fixing and positioning said elements in the optical instrument manufacture. Said carrier comprises carrying cylindrical rods arranged along light rays and connected to baseplates transversal with respect to said rods and embodied in the form of polygonal prisms. The rods are arranged in notches disposed along the perimeter of a lateral prismatic surface and formed by two intersecting surfaces parallel to the axis of the rod. Said notches can be formed by lateral faces of the prism and detachable strips connected thereto. The baseplates can be embodied in the form of two transversal parts connected to each other with the help of stays. The invention makes it possible to simplify the assembly and disassembly, and to use plates made of materials having the specified properties.

### FIELD OF THE INVENTION

The present invention relates to the field of optical instrument manufacture, namely to devices for fixing and positioning optical elements, and may be used in different fields of science and technology that carry out a physicochemical control and optico-physical measurements of parameters of articles to be produced, for example, in optics, instrument manufacture, mechanical engineering, chemical, food, microbiological industries and also in medicine.

### BACKGROUND OF THE INVENTION

There have been known adjusting carriers for optical elements, for example a multilense optical system comprising a cylindrical body with a base end, rimmed lenses with a base outside diameter (see, for example, RU Patent 2,047,878, Int. Cl. ⁶G02B 7/00, dated Feb. 1, 1993). This device has a considerable weight, the difficulty with assembly and adjustment. When replacing the used up optical elements or setting the new ones, disassembly of the entire device is required, followed by the system adjustment.

The closest prior art has been disclosed in an adjusting carrier for setting optical elements, that comprises carrying cylindrical rods arranged along light rays and connected to baseplates transversal with respect to said rods, and clamps contacting the rod. The carrying rods pass through openings in the baseplates (see, for example, a Microoptical Group, General Catalogue of “SPINDLER & HOYER KG”, Germany, 1986, p. 43).

The advantage of this configuration pattern of a group of optical elements consists in the uniformity of carrying elements, the ease of assembly and adjustment. This device, however, has disadvantages as well. The availability in the known device of a manufacturing clearance between the rods and openings in the plates results in the uncertainty of a position of basing the rods when the clamps are tightened, and thus in a drop in the rigidity of the device as a whole. It is impossible to adjust said clearance for wear. The device is very sensible to inaccuracies in the manufacture of the openings and rods, nonuniformity of their protective coatings, thereby resulting in a decrease in adaptability to efficient manufacture and assembly of such devices.

### SUMMARY OF THE INVENTION

It is an object of the present invention to overcome the above described drawbacks, simplify the manufacture of the device, reduce difficulties with the adjustment and operation of the device and improve its qualitative characteristics. The technical effect enabling the solution of the above object consists in the improvement of the device rigidity; a drop in the device sensitivity to inaccuracies in the manufacture of carrying rods and baseplates, even to the extent of making it possible to use the device with the same set of baseplates and rods of different diameter (including tubes) made of different materials. It is also envisaged to achieve a static determinateness in kinematic and adjustment displacements of the baseplates. Moreover, the technical effect consists in processing advantages. Such advantages reside in a grouped batch processing of parts, simplicity of design of compression moulds, dies and ingot moulds (for example, the absence of insertion cores), the manufacture of the baseplates without diamond drilling employing different materials, including brittle, composite ones, among them carbon-graphite, plastic, plastic with polycrystalline fillers, possessing special processing properties: high contact strength (crystals, metal ceramics), temperature stability (glass ceramics, granite), etc., a possibility to fix the position of the baseplates with respect to carrying rods with a cemented joint.

This object producing the above described technical effect is solved at the expense of a two-point contact of the rods in the baseplates. To accomplish this, in an adjusting carrier for setting optical elements comprising carrying cylindrical rods arranged along light rays and connected to baseplates transversal with respect to the rods, and clamps contacting the rod, the baseplates are embodied in the form of polygonal prisms; along the perimeter of a lateral prismatic surface of each baseplate there are disposed notches to accommodate said rods; two surfaces of said notches that contact the rod are arranged in intersecting planes parallel to the axis of the rod; the clamps are arranged such that a clamping force through the rod is distributed between two surfaces of a notch that contact the rod. For a better arrangement and simplicity of manufacture, surfaces of the notches that contact the rod and are parallel to its axis are arranged in planes that intersect perpendicular. The device in accordance with the present invention may be made yet more simply and accurately if the notches are formed by lateral faces of a prism and detachable strips connected to said lateral faces of the prism. First ends of detachable strips may stop short of a prism face edge. In a number of cases it is appropriate to manufacture the device such that second ends of the detachable strips stop short of another prism face edge, or such that the second ends of the detachable strips project beyond a prism face. In the latter case, the second ends of the detachable strips may be used as clamps that interact with the rod. An interesting solution enabling considerable simplification of the manufacture and adjustment consists in the accomplishment of the baseplates in the form of a prism with an even number of lateral faces; wherein the detachable strips are arranged on uneven faces and project from both ends beyond these faces; the rods are arranged on even faces in notches formed by projecting ends of the detachable strips; the clamps of the rods are embodied in the form of trapezoidal prisms installed on even faces of the baseplate; with lateral surfaces of said prisms contacting the rods. In case where the detachable strips do not project beyond the baseplate faces, the clamps may be used in the form of an elastic tension band embracing the rods and a baseplate along the external contour. To ease assembly and disassembly of the baseplates without disassembling the entire device, at least one baseplate is made of at least two transversal parts connected to each other with the help of stays. The stays are embodied in the form of connecting strips screwed on the baseplate parts, or the stays are embodied in the form of a housing made of elastic material, said housing embracing with its cramp the edges of the baseplate parts. The baseplates are made of a material possessing one or more special properties: high contact strength, high temperature stability, electrical-insulation properties. Such materials may be metal ceramics, glass ceramics, various crystalline materials, granite, glass, porcelain, a composite material, for example a carbon fiber reinforced plastic or plastic with a polycrystalline filler. For a greater stability, the baseplates are additionally fixed with respect to the rods, for example, with the help of screws passed through openings made as an assembly following a final adjustment of the device, or with the help of a glue line.

### BRIEF DESCRIPTION OF THE DRAWINGS

With reference to the accompanying three sheets of drawing:

FIG. 1 illustrates an adjusting carrier for setting optical elements, in which the first ends of detachable strips stop short of a hexagonal prism edge, and the second ends project beyond the prism face;

FIG. 2 illustrates an adjusting carrier, in which detachable strips project beyond the prism face from the both ends;

FIG. 3 illustrates an adjusting carrier with a baseplate consisting of two parts.

### BEST MODE TO CARRY OUT THE INVENTION

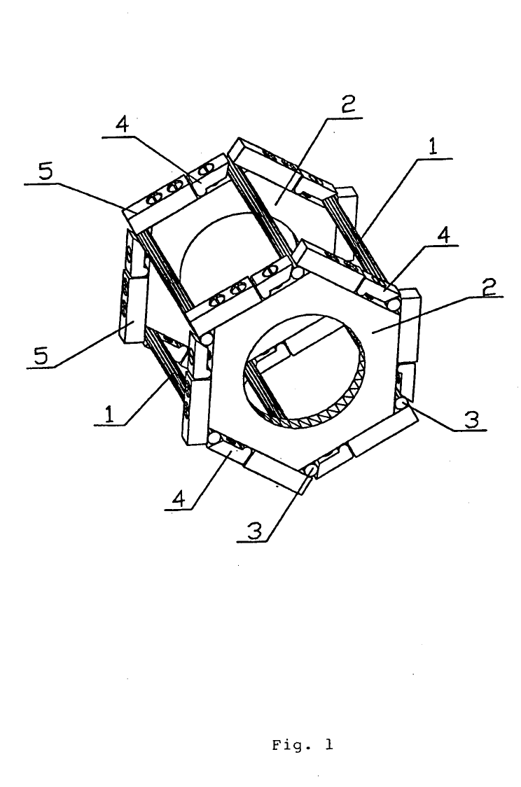

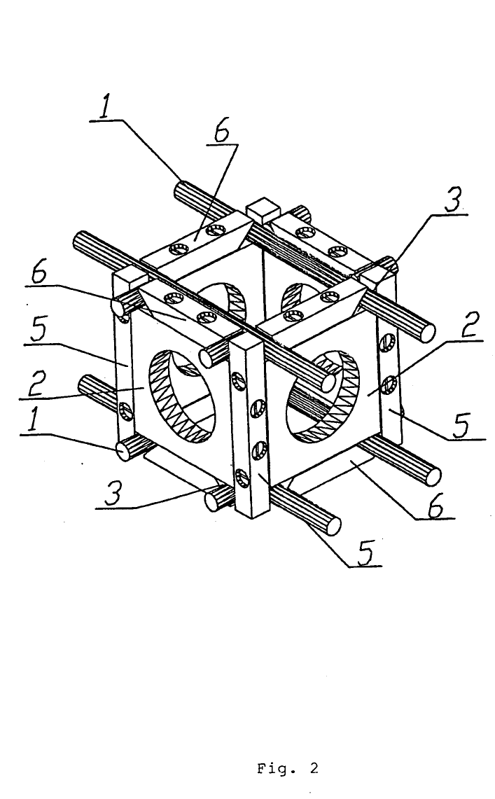

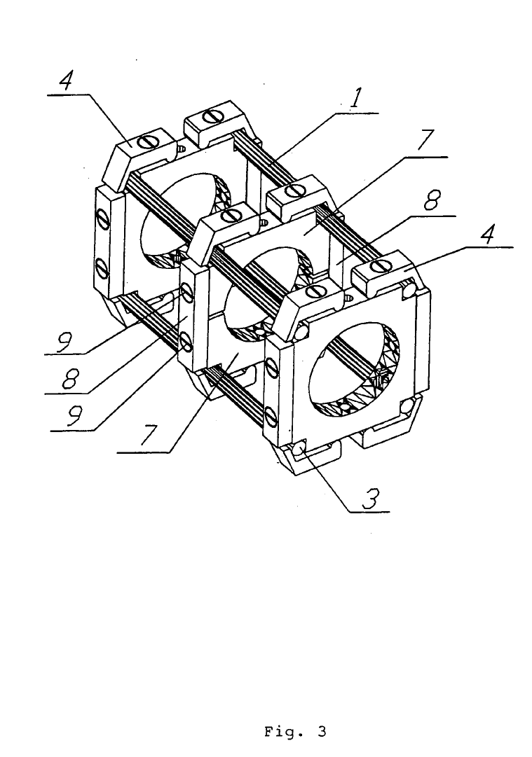

One of the best embodiments of the inventive device is illustrated by FIG. 1. An adjusting carrier for setting optical elements comprises carrying cylindrical rods 1 arranged along light rays and connected to baseplates 2 transversal with respect to the rods, said baseplates are embodied in the form of polygonal prisms. In this case, the baseplates are embodied in the form of hexagonal prisms with even faces. Along the perimeter of a lateral prismatic surface of each baseplate there are disposed notches 3, in which rods 1 are located. Two surfaces of each notch contact the rod and are arranged in intersecting planes with the both surfaces being parallel to the axis of the rod. In FIG. 1, the planes intersect at an angle of 60°, in FIG. 2 and FIG. 3—at an angle of 90° (the planes are perpendicular to each other). The rods are held in the notches by clamps 4, wherein a clamp plane is made inclined such that in the installation of a clamp a clamping force be distributed through the rod between two surfaces of a notch that contact the rod. The notches may be made in the baseplate 2 itself, for example in its angles (see FIG. 3) or formed by lateral faces of the prism and connected to the lateral faces of the prism by means of detachable strips 5. An embodiment is possible, in which one (the first) or the both (the first and second) ends of each strip stop short of a prism face edge. In contrast, the ends of the detachable strips may project beyond a prism face. FIG. 1 illustrates an embodiment where the first ends of the detachable strips stop short of a prism face edge, whereas the second ends project beyond a prism face while forming a notch 3 with an adjacent face. In this case, when the dimensions of the faces and detachable strips are observed strictly, the second ends of the detachable strips may serve the clamps contacting the rod (not shown in the drawing). FIG. 2 shows the arrangement of the device having two directions of light rays (perpendicular to each other in the drawing). Accordingly, the carrying rods in each direction are arranged along the path of each direction. FIG. 2 illustrates an embodiment where the baseplates are embodied in the form of a prism with even number of by lateral faces (in this case, they are square). Detachable strips 5 are located on uneven faces and project beyond a prism face with their both ends. Rods 1 are arranged on even faces in notches formed by a projecting end of the detachable strips; the clamps of the rods are embodied in the form of a detachable strip and an adjacent even face. Clamps may be individual for each rod or may be embodied in the form of trapezoidal prisms 6 installed on even faces, with lateral surfaces of said prisms each contacting its respective rod.

In an embodiment of the inventive device having rods projecting beyond the contour of a baseplate (with detachable strips), it is appropriate to use a baseplate in the form of an elastic tension band (not shown in the drawing) embracing the rods and a baseplate along the external contour.

For convenience of assembly and disassembly and also of removal or installation of additional baseplates without disassembling the entire device, at least one necessary baseplate is made of at least two parts 7 connected to each other with the help of stays 8. Referring to FIG. 3, a middle baseplate is made of two transversal parts 7 connected by stays 8 embodied in the form of connecting strips fastened on the both parts 7 of the baseplate with screws 9. For the speed of assembly and disassembly, the stays may be embodied in the form of a housing (not shown in the drawing) made of elastic material. Since the present invention enables one to manufacture baseplates without diamond drilling (the accomplishment of surfaces contacting the rod by means of diamond slitting, diamond grinding, etc), the baseplates are made of different brittle materials with special processing properties: high contact strength, high temperature stability, the specified electrical-insulation properties. The choice of any property or a combination of indicated properties of a material is dictated by necessary specifications of a device to be manufactured. Such materials may be metal ceramics, glass ceramics, a crystalline material (including single crystals), granite, glass, porcelain. For the manufacture of baseplates, it is interesting to use composite materials such as a carbon fiber reinforced plastic, various plastics, including plastic with a polycrystalline filler. It will be appreciated that the list of materials is not limited to those stated above. Owing to the design features of the device according to the present invention, any material having the prescribed special processing properties may be used.

Yet more stability of the device according to the present invention may be imparted by an additional fixation of the baseplates with respect to the rods with the help of screws or a glue line. The screws are arranged in openings passed through a baseplate and a carrying rod, said openings being accomplished following a final adjustment of the device.

### INDUSTRIAL APPLICABILITY

The inventive device was used for the manufacture of pilot samples of optical instruments. The tests showed good rigidity of the assembled system. The baseplates were easily replaced without disassembling the system. The samples were displayed in March 2000 at the fair in Hanover.

Although the present invention has been described with reference to a preferred embodiment, the invention is not limited to the details thereof, and various changes and modifications obvious to one skilled in the art to which the invention pertains are deemed to be within the spirit, scope and contemplation of the invention as further defined in the appended claims.

1. An adjusting carrier for setting optical elements comprising carrying cylindrical rods arranged along light rays and connected to baseplates transversal with respect to the rods, and clamps contacting the rod, characterized in that the baseplates are embodied in the form of polygonal prisms; along the perimeter of a lateral prismatic surface of each baseplate there are disposed notches to accommodate said rods; two surfaces of said notches that contact the rod are arranged in intersecting planes parallel to the axis of the rod; the clamps are arranged such that a clamping force through the rod is distributed between two surfaces of a notch that contact the rod.

2. An adjusting carrier as claimed in claim 1, characterized in that surfaces of the notches that contact the rod and are parallel to its axis are arranged in planes that intersect perpendicular.

3. An adjusting carrier as claimed in claim 1, characterized in that the notches are formed by lateral faces of a prism and detachable strips connected to said lateral faces of the prism.

4. An adjusting carrier as claimed in claim 3, characterized in that first ends of detachable strips stop short of a prism face edge.

5. An adjusting carrier as claimed in claim 4, characterized in that second ends of the detachable strips stop short of another prism face edge.

6. An adjusting carrier as claimed in claim 4, characterized in that the second ends of the detachable strips project beyond a prism face.

7. An adjusting carrier as claimed in claim 6, characterized in that the second ends of the detachable strips are clamps that interact with the rod.

8. An adjusting carrier as claimed in claim 3, characterized in that the baseplates are embodied in the form of a prism with an even number of lateral faces; detachable strips are arranged on uneven faces and project from both ends beyond these faces; rods are arranged on even faces in notches formed by projecting ends of the detachable strips; clamps of the rods are embodied in the form of trapezoidal prisms installed on even faces of the baseplate; with lateral surfaces of said prisms contacting the rods.

9. An adjusting carrier as claimed in claim 1 characterized in that the clamps are used in the form of an elastic tension band embracing the rods and a baseplate along the external contour.

10. An adjusting carrier as claimed in claim 1, characterized in that at least one baseplate is made of at least two transversal parts connected to each other with the help of stays.

11. (canceled).

12. An adjusting carrier as claimed in claim 10 characterized in that the stays are embodied in the form of a housing made of elastic material.

13. An adjusting carrier as claimed in claim 1, characterized in that the baseplates are made of a material with high contact strength and/or high temperature stability and/or electrical-insulation properties.

14. An adjusting carrier as claimed in claim 13, characterized in that the baseplates are made of metal ceramics.

15. An adjusting carrier as claimed in claim 13, characterized in that the baseplates are made of glass ceramics.

16. (canceled).

17. (canceled).

18. An adjusting carrier as claimed in claim 13, characterized in that the baseplates are made of glass.

19. An adjusting carrier as claimed in claim 13, characterized in that the baseplates are made of porcelain.

20. An adjusting carrier as claimed in claim 13, characterized in that the baseplates are made of a composite material.

21. (canceled).

22. An adjusting carrier as claimed in claim 20, characterized in that the baseplates are made of plastic with a polycrystalline filler.

23. An adjusting carrier as claimed in claim 1, characterized in that the baseplates are additionally fixed with respect to the rods.

24. An adjusting carrier as claimed in claim 23, characterized in that the baseplates are additionally fixed with respect to the rods with the help of screws passed through openings made as an assembly following a final adjustment of the device.

25. (canceled).
